(19) United States
(12) Patent Application Publication
(10) Pub. No.: US 2009/0076724 A1
(43) Pub. Date: Mar. 19, 2009

(54) Apparatus and program for navigation

(75) Inventors: Keita Kobayashi, Kariya-city (JP); Makoto Tanaka, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/232,545

(22) Filed: Sep. 18, 2008

(30) Foreign Application Priority Data
Sep. 19, 2007 (JP) 2007-242272

(51) Int. Cl. G01C 21/30

(52) U.S. Cl. 701/209

(57) ABSTRACT

A vehicular navigation apparatus reads from an external memory a highland flag that is turned on when a vehicle travels at an altitude of 3,000 meters or higher, and prohibits an operation of a hard disk drive (HDD) if the highland flag is turned on. By prohibiting the hard disk drive operation, the hard disk drive is protected from breakage due to an access from the navigation apparatus in a travel of the vehicle through the highland.

### CROSS REFERENCE TO RELATED APPLICATION

The present application is based on and claims the benefit of priority of Japanese Patent Application No. 2007-242272 filed on Sep. 19, 2007, the disclosure of which is incorporated herein by reference.

### FIELD OF THE INVENTION

The present disclosure generally relates to a navigation apparatus for use in a vehicle.

### BACKGROUND INFORMATION

Conventionally, vehicular navigation apparatuses having, as a storage medium, a hard disk drive for storing and displaying a map around a current position based on map data and for calculating and guiding an appropriate route toward a destination of a travel are widely used. Further, not only the map data but also application software used in the navigation apparatus as well as music and video data for use in an audio system that is integrated to the navigation apparatus are stored in a large capacity storage that uses the hard disk drive.

The hard disk drive uses a magnetic head for reading and writing information on a disk shape storage medium that has a layer of magnetic material applied thereon. At the time of operation of the hard disk drive, the magnetic head located above a disk is raised therefrom by a pressure of air induced by the rotating disk by a small amount of distance. Therefore, a gap between the magnetic head and the disk cannot be maintained in an appropriate condition due to a decrease of the air pressure for raising the magnetic head when the hard disk drive is operated in an environment where atmospheric pressure is extremely lowered. As a result, the magnetic head collides with the disk to cause disk breakage. That is, in other words, the hard disk drive has a restriction for use in terms of altitude due to the decrease of the atmospheric pressure that is in proportion to the increase of the altitude. In general, the operation of the hard disk drive is guaranteed up to an altitude of 3,000 meters to 5,000 meters (i.e., down to 0.7 to 0.5 atmospheric pressure).

Therefore, when the apparatus having the hard disk drive is expected to be used in a highland that is higher than use guarantee altitude (e.g., a road in a highland at an altitude of 3,000, 4,000 or 5,000 meters), a disk breakage prevention measure is required.

A technique for coping with the highland travel problem of the hard disk drive is disclosed, for example, in a Japanese patent document JP-A-2004-317385 (U.S. Pat. No. 7,171,305). The technique in the above disclosure stores (i.e., copies) a part of the map data that is originally memorized on the hard disk drive to an external memory prior to stopping the operation of the hard disk drive when the vehicle reaches a highland at a predetermined altitude (e.g., altitude of 3,000 meters), and performs navigation operation based on the map data in the external memory while the vehicle travels the highland above the predetermined altitude. The above technique prevents the breakage of the hard disk drive in a travel of the highland while enabling a continuation of the navigation operation.

However, the protection of the hard disk drive is achieved by the technique in the above disclosure only for a situation where the vehicle goes into a highland at an altitude of 3,000 meters or higher while the vehicle is traveling. That is, the above solution does not expect that the operation of the navigation apparatus is started at a highland that is above the predetermined use guarantee altitude. In other words, the above disclosure does not expect a situation where the navigation apparatus starts its operation to have an access to the hard disk drive at an altitude of 3,000 meters or higher. Therefore, the following problems arise for the navigation apparatus that uses the technique of the above disclosure.

That is, the conventional vehicular navigation apparatus having the hard disk drive has an access to the hard disk drive for reading required application program and/or map data into a work memory from the hard disk drive when the travel of the vehicle is started and the navigation apparatus is operated. Therefore, when the vehicle is re-started subsequent to the stopping in a highland of 3,000 meter or higher, that is, subsequent to the stopping of the operation of the navigation apparatus in the vehicle, the navigation apparatus has an access to the hard disk drive as a normal start processing for data retrieval, thereby possibly causing the damage to the hard disk drive due to the operation of the hard disk drive in the highland above the use guarantee altitude.

### SUMMARY OF THE INVENTION

In view of the above and other problems, one aspect of the present invention provides a technique that prevents a breakage of a hard disk drive in a highland that is higher than an operation guarantee altitude of the hard disk drive.

A vehicular navigation apparatus of the present invention includes: a hard disk drive serving as a storage for storing map data that is used for route guidance; an altitude information storage unit for storing altitude information even when an operation of the navigation apparatus is halted; an altitude acquisition unit for acquiring a current altitude; a threshold determination unit for determining whether the current altitude is a high altitude that is equal to or higher than a threshold during a travel of a vehicle; an altitude save unit for saving the current altitude when the current altitude is determined to be the high altitude; and an activation control unit for prohibiting an operation of the hard disk drive in a course of activation of the navigation apparatus from a halted condition if the altitude information retrieved from the altitude information storage unit indicates the high altitude.

The threshold of the high altitude may be determined as an upper limit of the use guarantee altitude of the hard disk drive, or, alternatively, the threshold may be determined for a lower limit of the atmospheric pressure that serves as an equivalent to the upper limit of the use guarantee altitude.

The altitude save unit has a configuration that allows an operable at the highland above the upper limit of the use guarantee altitude of the hard disk drive. That is, for example, a volatile memory that retains its memory contents with a provision of electric power (e.g., a RAM), a non-volatile memory that retains its memory contents without a supply of electric power, an optical and/or magneto-optical disk may be used as the altitude save unit.

The vehicular navigation apparatus having the above-described configuration saves altitude information in an information storage, examines the altitude information at the start of the operation of the navigation apparatus, and prohibits the operation of the hard disk drive if the altitude information indicates that the vehicle is in the highland above the threshold. Therefore, even when the operation of the vehicle is started at the altitude that exceeds the use guarantee altitude of the hard disk drive, the breakage of the hard disk drive is prevented due to the prohibition of the operation of the hard disk drive. The operation of the hard disk drive may be started when the altitude information from the external source or from the storage in the apparatus indicates that the current altitude is not the highland higher than threshold.

### BRIEF DESCRIPTION OF THE DRAWINGS

Other objects, features and advantages of the present invention will become more apparent from the following detailed description made with reference to the accompanying drawings, in which:

FIG. 1 shows a block diagram showing outline configuration of a vehicle navigation apparatus;

FIG. 2 shows a flow chart showing a process of operation mode control in a first embodiment of the present invention;

FIG. 3 shows a flow chart showing a process of activation control in the first embodiment;

FIG. 4 shows a flow chart showing a process of activation control in a second embodiment;

FIG. 5 shows a flow chart showing a process of operation mode control in a third embodiment;

FIG. 6 shows a flow chart showing a process of activation control in a third embodiment;

FIG. 7 shows a flow chart showing a process of operation mode control in a fourth embodiment; and

FIG. 8 shows a flow chart showing a process of activation control in the fourth embodiment.

### DETAILED DESCRIPTION

An embodiment of the present invention is explained with reference to the drawing.

(1. Navigation Apparatus Configuration)

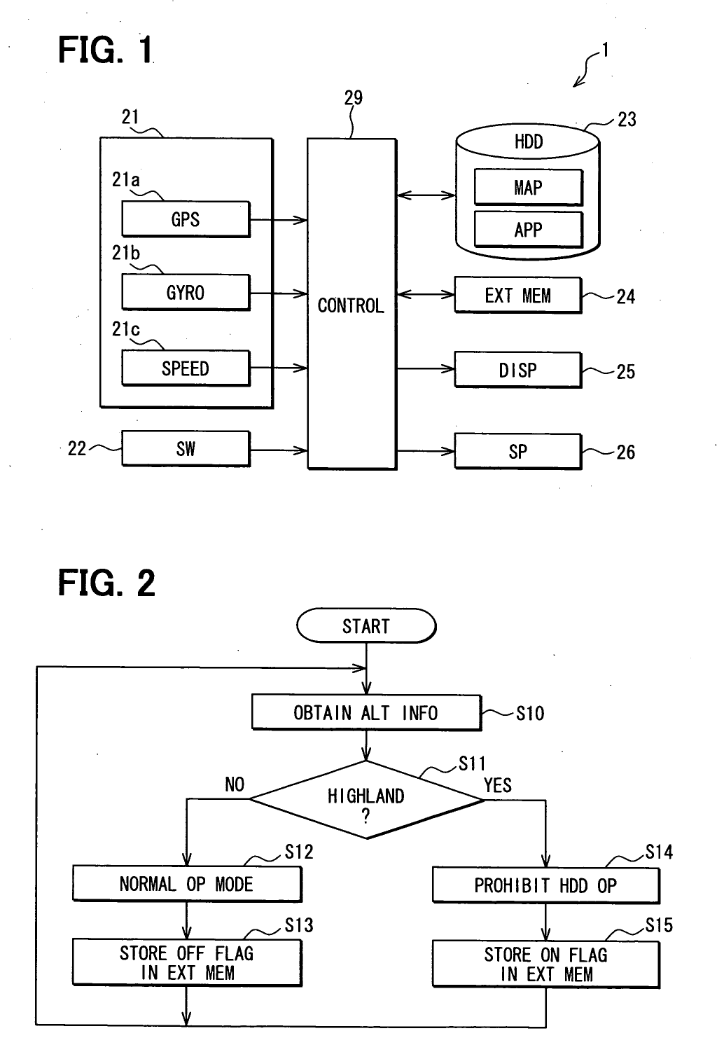

FIG. 1 is a block diagram showing outline configuration of a navigation apparatus 1 for use in a vehicle in an embodiment of the present invention.

The navigation apparatus 1 has a position sensor 21 detecting a current position of the vehicle, an operation switch group 22 inputting various instructions from a user, a hard disk drive (an HDD) 23 which is mass storage for map data, application programs and the like, an external memory 24 storing various information, a display unit 25 displaying various screens such as a map display screen and the like, a voice-output unit 26 outputting various guide sounds and the like, and a control unit 29 as shown in FIG. 1.

The position sensor 21 includes a GPS receiver 21a that receives a GPS signal from a GPS satellite through a GPS antenna and detects position coordinates and an altitude of the vehicle, a gyroscope 21b that outputs a detection signal of an angular velocity of rotary motion being applied to the vehicle, and a speed sensor 21c that outputs a detection signal of vehicle speed. These sensors 21a to 21c yields errors of respectively different natures, and those errors are compensated with each other by employing data from other sensors.

The operation switch group 22 is provided as a touch panel that is integrally formed on a display screen of the display unit 25 and/or mechanical key switches disposed around the display unit 25. The hard disk drive (HDD) 23 is a combination of components such as a hard disk for storing information and a drive unit including a magnetic head to read and write information from/to the hard disk, a driver, a controller and the like. Data stored in the HDD 23 includes road data for map matching, route searching, route guidance and the like, map data required for drawing maps, data for route navigation, application programs for the operation of the navigation apparatus 1 and other data. In addition, the HDD 23 is assumed to be operated at an altitude of 3,000 m or an altitude lower than that. The operation condition in terms of the altitude may be described as an operation condition of 0.7 atmospheric pressure or a pressure higher than that.

The external memory 24 is used for storing a high highlands flag (mentioned later), mode information, map data and a part of the application program memorized on the HDD 23. The external memory 24 may be consists of a storage device such as, for example, a non-volatile semiconductor memory which is capable of re-writing memory contents electrically or magnetically, and is capable of maintaining memory contents during a halted condition of the navigation apparatus 1. In addition, the external memory 24 may be constituted from different kinds of memories in plural units.

The display unit 25 is a color display device having the display screen of liquid crystal display unit or the like. The display unit 25 is capable of displaying various images on the display screen depending on the input of the video signal from the control unit 29. For example, the image on the display screen may be constituted of a current position marking specified by the current position of the vehicle detected by the position sensor 21 and by the map data from the HDD 23, a guidance route to the destination, land names, signs, and additional data of such as landmarks or the like in an overlapping manner.

The voice-output unit 26 is a device capable of notifying the user of various information by a sound. The sound from the voice-output unit 26 in combination with the display on the display unit 25 provides the user with various guidance such as a route guidance or the like.

The control unit 29 is a well-known device such as a microcomputer including a CPU, a ROM, a RAM, an I/O and a bus line connecting these devices for providing control of each of the components described above. The control unit 29 carries out various kinds of processing according to the application program and data retrieved from the ROM, the HDD 23, and the external memory 24 or the like.

For example, the navigation-related processing includes map display processing, route guidance processing and the like. As for the map display processing, the current position of the vehicle is calculated based on each of the detection signal from the position sensor 21 and the map of current position neighborhood read from the HDD 23 is displayed on the display unit 25. As for the route guidance processing, the guidance route is calculated as an optimum route from the current position to the destination based on the location data stored on the HDD 23 and navigation for the travel is provided in consideration of the relation between the current position and the destination. As a technique to automatically set the optimum route, cost estimation technique by Dijkstra method is known among other methods.

Further, the navigation apparatus 1 is expected to be used in a highland with an altitude that exceeds an upper limit altitude of a normal operation of the HDD 23 (i.e., an operation guarantee altitude of the HDD 3). The upper limit altitude may be 3,000 meters or the like. Therefore, the control unit 29 carries out following processing to restrict the hard disk drive operation in the highland.

That is, when the vehicle reaches the highland higher than an altitude of 3,000 meters during the travel, the breakage of the HDD 23 is prevented by prohibiting the operation of the HDD 23 in the highland. In addition, at the start of the operation of the navigation apparatus 1, the operation of the HDD 23 is prohibited when the current position is in the highland. By the above operation scheme, the breakage of the HDD 23 by operating the HDD 23 at the start of the operation of the navigation apparatus 1 in association with re-starting a travel of the vehicle subsequent to the end of the travel in the highland can be prevented.

The details of the operation restriction scheme of the HDD 23 in the highland are described later.

The outline of the configuration of the navigation apparatus 1 explained in the above description leads to the correspondence between the components in the embodiment and elements claiming language in the following description. That is, the position detector 21 in the navigation apparatus 1 corresponds to an altitude acquisition unit; the external memory 24 corresponds to an altitude storage unit and a second storage unit; and the control unit 29 corresponds to an threshold determination unit, a data control unit, a command unit, an altitude save unit, and an activation control unit.

(2-1. Processing Performed by the Control Unit)

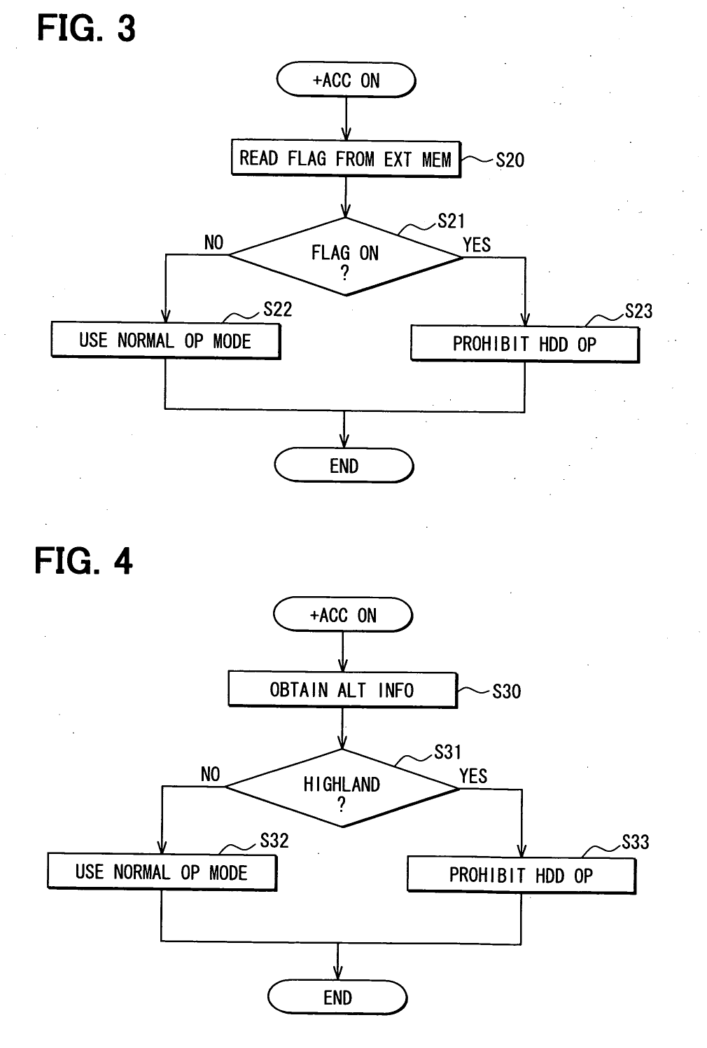

An explanation of an operation mode control processing and an activation control processing performed by the control unit 29 is provided in detail as a first embodiment of the present invention with reference to flow charts in FIGS. 2 and 3.

(2-1-1. Operation Mode Control Processing)

FIG. 2 is a flow chart showing a process of the operation mode control processing in the first embodiment that control unit 29 carries out. The processing is started promptly after the navigation apparatus 1 is started due to a turn-on of the accessories switch (ACC SW) of the vehicle, and the processing is carried out in parallel with the above-mentioned map display processing, the route guidance processing or the like.

First, the control unit 29 acquires measurement of the altitude information of the current position of the vehicle from the GPS receiver 21a (S10). Then, based on the altitude that is indicated by the acquired altitude information, whether or not the current position is in the highland is determined (S11). In the present embodiment, an altitude of 3,000 meters or higher is defined as the highland. The definition of the highland may be changed to a different value depending on a specification of the HDD 23. In addition, the altitude of the current position may also be determined based on a pressure of the atmosphere acquired from a barometer (not shown in the drawing) beside being determined by the measurement of the GPS system. The atmospheric pressure of the altitude of 3,000 meters is defined as 0.7.

When the current position is not determined in the highland in S11 (S11: NO), in other words, when the altitude is under 3,000 meters, or the atmospheric pressure is 0.7 or greater, an operation of the navigation apparatus 1 in a normal operation mode that allows the map display processing and/or the route guidance processing with the operation of the HDD 23 being allowed is carried out (S12). In the normal operation mode, various data which are memorized on the HDD 23 is retrieved by an access to the HDD 23, and the above-mentioned map display processing or route guidance processing are carried out as usual based on the retrieved datan, a flag that indicates a state that the current position of the vehicle is in the highland is turned off to be stored in the external memory 24 (S13), and the processing returns to S10.

On the other hand, when the current position is not determined in the highland in S11 (S11: YES), in other words, when the altitude is equal to or greater than 3,000 meters, or the atmospheric pressure is smaller than 0.7, the operation of the HDD 23 is prohibited (S14). The flag is stored in the external memory 24 with its state being turned off (S15), and the processing returns to S10.

(2-1-2. Activation Control Processing)

FIG. 3 is a flow chart showing processing of the above-mentioned activation control processing that is performed by the control unit 29 in the first embodiment. The activation control processing is performed when the navigation apparatus 1 is activated or started due to turning of the accessories switch of the vehicle from an off condition (the navigation apparatus 1 is in a halted condition) to an on condition.

At first, the control unit 29 retrieves the flag (i.e., a highland flag) memorized in the external memory 24 (S20) when the ACC SW is turned on. The external memory 24 stores the highland flag in a condition that is immediately before turning off of the ACC SW (i.e., immediately before the end of the last operation of the navigation apparatus 1 from the operation mode control processing (cf. FIG. 2).

Then, whether or not the highland flag is “on” is determined (S21). When the highland flag is determined to be “off” (S21: NO), the operation in the normal operation mode for performing the map display processing or the route guidance process in the state where the operation of the HDD 23 is allowed is started (S22). In the normal operation mode, various data which are memorized on the HDD 23 is retrieved by an access to the HDD 23, and the above-mentioned map display processing or route guidance process are carried out based on the retrieved data as usual.

In addition, the condition that the highland flag is off at the time immediately before the end of the last operation can be interpreted as that the position where the vehicle is stopping is not the highland. Because the breakage of the HDD 23 due to the operation in the highland is not expected, the operation of the navigation apparatus 1 is started in the normal operation mode that allows an access to the HDD 23 at the re-start time of the operation of navigation apparatus 1.

On the other hand, the operation of the HDD 23 is prohibited (S23) when the retrieved highland flag is determined to be “on” (S21: YES). The condition that the highland flag is “on” at the time immediately before the end of the prior operation can be interpreted as that the position where the vehicle is stopping is in the highland. Therefore, the operation of the HDD 23 is prohibited at the re-start time of the navigation apparatus 1 for preventing the breakage of the HDD 23 due to the operation of the HDD 23 in the highland.

Due to the prohibition of the HDD operation, though the application that requires data retrieval from the HDD 23 cannot be executed, the measurement of the altitude by the GPS receiver 21a can be performed. In addition, the operation mode control processing can be started (cf. FIG. 2) during the operation stopping period of the HDD 23 if the program for the operation mode control processing is stored in the ROM of the control unit 29 or the external memory 24. Therefore, if the operation of the HDD 23 is prohibited at the start time of the navigation apparatus 1, the operation of the HDD 23 is permitted according to the operation mode control processing and the operation in the normal mode is started when the vehicle leaves the highland.

(2-1-3. Modification to the Activation Control Processing)

The modification of the activation control processing in the first embodiment is described in the following. In the modified form, the breakage of the HDD 23 is prevented even when the highland flag is not stored in the external memory 24 for unknown reason, or even when the highland flag in the external memory 24 is accidentally erased.

(1)

When a volatile memory is used as a storage of the highland flag, the memory contents (i.e., the condition of the flag) is retained by a power supply from the vehicle battery during a halted condition of the navigation apparatus 1. However, the flag condition memorized in the volatile memory is lost when the power supply is terminated due to the low battery or due to the cut off of the power circuit for maintenance.

Therefore, when the navigation apparatus 1 is re-started after the cut off of the power supply from the vehicle during the halt of the navigation apparatus 1, the altitude of the current position is acquired by the GPS receiver 21a, and whether or not the current position is in the highland is determined, in a manner described as S10 and S11 in the flow chart of the FIG. 2. Then, the operation of the HDD 23 is prohibited when the current position is determined to be in the highland.

(2)

When a removable memory such as, for example, a memory card is used as a storage of the highland flag, the mode information can not be retrieved at the (re-)start time of the navigation apparatus 1 in case that the memory card is removed or the memory card is replaced during the halt of the navigation apparatus 1.

Therefore, at the start time of the navigation apparatus 1, the storage of the highland flag in the external memory 24 is examined. If the highland flag condition is stored in the memory 24, the processing of the activation control is performed. If the mode information (i.e., the flag condition) is not stored, the altitude of the current position is acquired by the GPS receiver 21a, and whether or not the current position is in the highland is determined, in a manner shown in S10 and S11 in FIG. 2. If the current position is determined to be in the highland, the operation of the HDD 23 is prohibited.

(2-2. Another Processing Performed by the Control Unit)

An explanation of an operation mode control processing and an activation control processing performed by the control unit 29 is provided in detail as a second embodiment of the present invention.

(2-2-1. Operation Mode Control Processing)

As described in the first embodiment (refer to FIG. 2), the operation of the HDD 23 is prohibited (S14) when the current position is determined to be in the highland (S11: YES), with an exception that the processing in S13 and S15 for storing the condition of the highland flag in the external memory 24 is omitted. In other words, the operation mode control processing in the second embodiment repeatedly performs only S10, S11, S12, and S14 of the same processing in the first embodiment. The contents of those steps in the operation mode control processing are same as the first embodiment, and thereby not being described again in the present embodiment.

(2-2-2. Activation Control Processing)

FIG. 4 is a flow chart showing a processing of activation control processing in the second embodiment that is performed by the control unit 29. The activation control processing is performed when the navigation apparatus 1 is activated or started due to turning of the accessories switch of the vehicle from an off condition (the navigation apparatus 1 is in a halted condition) to an on condition.

When the accessories switch is turned on, the control unit 29 acquires the altitude information of the current position of the vehicle by the GPS receiver 21a (S30). Then, based on the altitude that indicated by the acquired altitude information, whether or not the current position is in the highland that is equal to or higher than an altitude of 3,000 meters is determined (S31). The determination of the altitude may be based on the GPS measurement from the GPS receiver 21a, or may be based on the atmospheric pressure by using the barometer. In this case, the atmospheric pressure equivalent to the altitude of 3,000 meters is defined as a pressure smaller than 0.7 atmospheric pressure.

When the current position is not determined to be in the highland in S31 (S31: NO), in other words, when the altitude is under 3,000 meters, or the atmospheric pressure is 0.7 or greater, an operation of the navigation apparatus 1 in the normal operation mode that allows the map display processing and/or the route guidance processing with the operation of the HDD 23 being allowed is carried out (S32). In the normal operation mode, various data which are memorized on the HDD 23 is retrieved by an access to the HDD 23, and the above-mentioned map display processing or route guidance processing are carried out as usual based on the retrieved data.

On the other hand, When the current position is not determined in the highland in S31 (S31: YES), in other words, when the altitude is equal to or greater than 3,000 meters, or the atmospheric pressure is smaller than 0.7, the operation of the HDD 23 is prohibited (S33).

Due to the prohibition of the HDD operation, though the application that requires data retrieval from the HDD 23 cannot be executed, the measurement of the altitude by the GPS receiver 21a can be performed. In addition, the operation mode control processing can be started during the operation stopping period of the HDD 23 if the program for the mode control processing is stored in the ROM of the control unit 29 or the external memory 24. Therefore, if the operation of the HDD 23 is prohibited at the start time of the navigation apparatus 1, the operation of the HDD 23 is permitted according to the operation mode control processing and the operation in the normal mode is started when the vehicle leaves the highland.

(2-3. Yet Another Processing Performed by the Control Unit)

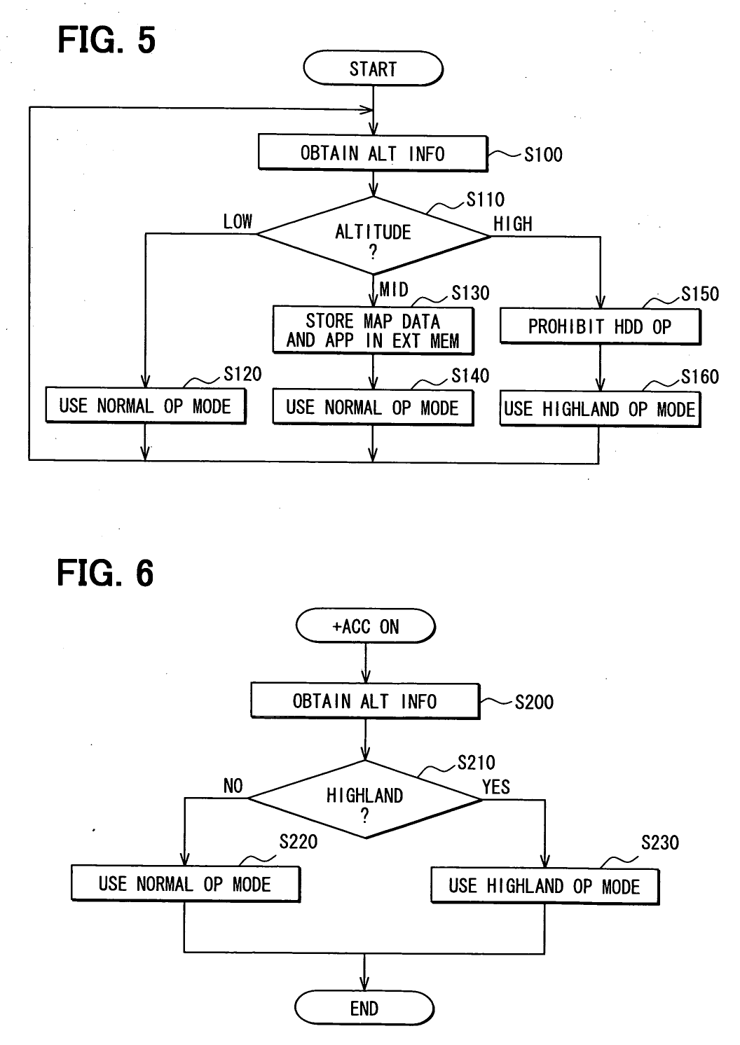

An explanation of an operation mode control processing and an activation control processing performed by the control unit 29 is provided in detail as a third embodiment of the present invention with reference to flow charts in FIGS. 5 and 6.

(2-3-1. Operation Mode Control Processing)

FIG. 5 is a flow chart showing a process of the above-mentioned operation mode control processing that is performed by the control unit 29 in the third embodiment of the present invention. The processing is started promptly after the navigation apparatus 1 is started due to a turn-on of the accessories switch (ACC SW) of the vehicle, and the processing is carried out in parallel with the above-mentioned map display processing, the route guidance processing or the like.

First, the control unit 29 acquires measurement of the altitude information of the current position of the vehicle from the GPS receiver 21a (S100). Then, based on the altitude that is indicated by the acquired altitude information, whether the current position is in the highland, a quasi-highland, or a lowland is determined (S110). In the present embodiment, an altitude of 3,000 meters or higher is defined as the highland, an altitude between 2,900 meters and 3,000 meters is defined as the quasi-highland, and an altitude smaller than 2,900 meters is defined as the lowland. The definition of the highland to lowland may be changed to a different value depending on a specification of the HDD 23.

When the current position is determined to be in the lowland in S110 (S110: LOW), in other words, when the altitude of the current position is smaller than 2,900 meters, an operation of the navigation apparatus 1 in the normal operation mode that allows the map display processing and/or the route guidance processing with the operation of the HDD 23 being allowed is carried out (S120). In the normal operation mode, various data which are memorized on the HDD 23 is retrieved by an access to the HDD 23, and the above-mentioned map display processing or route guidance processing are carried out as usual based on the retrieved data.

On the other hand, when it is determined that the current position is determined to be in the quasi-highland in S110 (S110: MID), in other words, when the altitude of the current position is equal to or greater than 2,900 meters and smaller than 3,000 meters, a part of the map data memorized on the HDD 23 and the application program for displaying a map based on the map data are retrieved and stored in the external memory 24 (S130). Then, a normal operation mode for performing the map display processing and/or route guidance processing in the state that the operation of the HDD 23 is being allowed is carried out (S140).

The map data stored in the external memory 24 may cover a predetermined range that centers around the current vehicle position. Further, the highland with the altitude of 3,000 meters or greater is expected to be scattered in a spotted manner on the map, map data that covers an entire area of the highland nearest to the current vehicle position may be stored in the external memory 24.

On the other hand, when the current position is not determined in the highland in S110 (S110: HIGH), in other words, when the altitude is equal to or greater than 3,000 meters, the operation of the HDD 23 is prohibited (S150). Then, a highland operation mode is performed (S160). In the highland operation mode, the map display is continued based on the data stored in the external memory 24 with an access to the HDD 23 being prohibited. In the highland operation mode, the application program for map display and the map data are retrieved from the external memory 24 and the map display is continued for an area around the current vehicle position based on the retrieved data.

(2-3-2. Activation Control Processing)

FIG. 6 is a flow chart showing a processing of the above-mentioned activation control processing that is performed by the control unit 29 in the third embodiment. The activation control processing is performed when the navigation apparatus 1 is activated or started due to turning of the accessories switch of the vehicle from an off condition (the navigation apparatus 1 is in a halted condition) to an on condition.

When the accessories switch is turned on, the control unit 29 acquires the altitude information of the current position of the vehicle by the GPS receiver 21a (S200). Then, based on the altitude that indicated by the acquired altitude information, whether or not the current position is in the highland that is equal to or higher than an altitude of 3,000 meters is determined (S210). The determination of the altitude may be based on the GPS measurement from the GPS receiver 21a, or may be based on the atmospheric pressure by using the barometer (not shown in the drawing). In this case, the atmospheric pressure equivalent to the altitude of 3,000 meters is defined as a pressure smaller than 0.7 atmospheric pressure.

When the current position is not determined to be in the highland in S210 (S210: NO), in other words, when the altitude is under 3,000 meters, or the atmospheric pressure is 0.7 or greater, an operation of the navigation apparatus 1 in the normal operation mode that allows the map display processing and/or the route guidance processing with the operation of the HDD 23 being allowed is started (S220). In the normal operation mode, various data which are memorized on the HDD 23 is retrieved by an access to the HDD 23, and the above-mentioned map display processing or route guidance processing are carried out as usual based on the retrieved data.

On the other hand, when the current position is not determined in the highland in S210 (S210: YES), in other words, when the altitude is equal to or greater than 3,000 meters, or the atmospheric pressure is smaller than 0.7, an operation of the navigation apparatus 1 in the highland operation mode for continuing the map display based on the data stored in the external memory 24 is started with the operation of the HDD 23 being prohibited (S230). In the highland operation mode, the application program for map display and the map data are retrieved from the external memory 24 and the map display is continued for an area around the current vehicle position based on the retrieved data.

Due to the prohibition of the HDD operation, though the application that requires data retrieval from the HDD 23 cannot be executed, the measurement of the altitude by the GPS receiver 21a can be performed. In addition, the operation mode control processing can be started (cf. FIG. 5) during the operation stopping period of the HDD 23 if the program for the operation mode control processing is stored in the ROM of the control unit 29 or the external memory 24. Therefore, if the operation of the HDD 23 is prohibited at the start time of the navigation apparatus 1, the operation of the HDD 23 is permitted according to the operation mode control processing and the operation in the normal mode is started when the vehicle leaves the highland.

(2-4. Still Yet Another Processing Performed by the Control Unit)

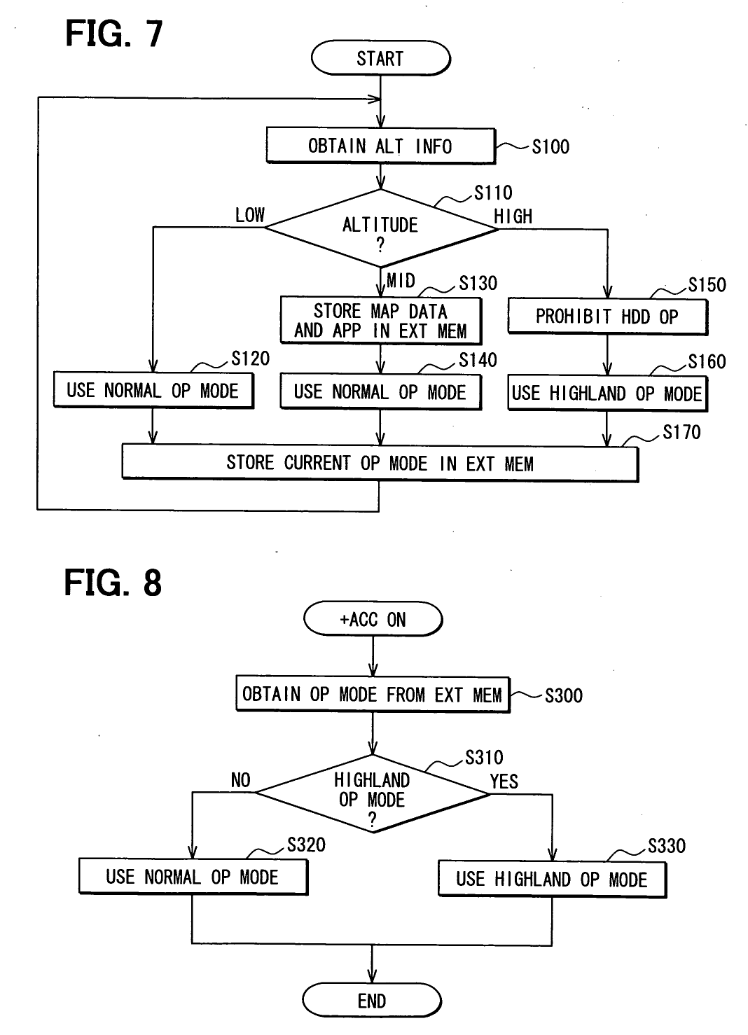

An explanation of an operation mode control processing and an activation control processing performed by the control unit 29 is provided in detail as a fourth embodiment of the present invention with reference to flow charts in FIGS. 7 and 8.

(2-4-1. Operation Mode Control Processing)

FIG. 7 is a flow chart showing a process of the above-mentioned operation mode control processing that is performed by the control unit 29 in the fourth embodiment of the present invention. The processing is started promptly after the navigation apparatus 1 is started due to a turn-on of the accessories switch (ACC SW) of the vehicle, and the processing is carried out in parallel with the above-mentioned map display processing, the route guidance processing or the like.

The operation mode control processing in the fourth embodiment is different from the same processing in the third embodiment (cf. FIG. 5) at a point that S170 is added subsequent to S120, S140, and S160 in the processing. The contents of S170 is that the current operation mode that is being started in each of the steps of S120, S140, S160 is stored in the external memory 24 before returning to S100.

(2-4-2. Activation Control Processing)

FIG. 8 is a flow chart showing a processing of the above-mentioned activation control processing that is performed by the control unit 29 in the fourth embodiment. The activation control processing is performed when the navigation apparatus 1 is activated or started due to turning of the accessories switch of the vehicle from an off condition (the navigation apparatus 1 is in a halted condition) to an on condition.

At first, the control unit 29 retrieves mode information stored in the external memory 24 when the ACC SW is turned on (S300). The external memory 24 stores the mode information indicating the operation mode at a time that is immediately before the end of the last operation of the navigation apparatus 1.

Then, whether or not the acquired mode information is the highland operation mode is determined (S310). When the current mode is not the highland operation mode (S310: NO), an operation of the navigation apparatus 1 in the normal operation mode that allows the map display processing and/or the route guidance processing with the operation of the HDD 23 being allowed is started (S320). In the normal operation mode, various data which are memorized on the HDD 23 is retrieved by an access to the HDD 23, and the above-mentioned map display processing or route guidance processing are carried out as usual based on the retrieved data.

In addition, the normal operation mode is used at the time immediately before the end of the last operation can be interpreted as that the position where the vehicle is stopping is not the highland. Because the breakage of the HDD 23 due to the operation in the highland is not expected, the operation of the navigation apparatus 1 is started in the normal operation mode that allows an access to the HDD 23 at the re-start time of the operation of navigation apparatus 1.

On the other hand, an operation of the navigation apparatus 1 for continuing the map display based on the data stored in the HDD 23 is started with the operation of the HDD 23 being prohibited (S330) when the mode information indicates that the current position is in the highland (S320: YES). In the highland operation mode, the application program for map display and the map data are retrieved from the external memory 24 and the map display is continued for an area around the current vehicle position based on the retrieved data.

In addition, the highland operation mode is used at the time immediately before the end of the last operation can be interpreted as that the position where the vehicle is stopping is in the highland. Because the breakage of the HDD 23 due to the operation in the highland is expected, the operation of the navigation apparatus 1 is started in the highland operation mode that prohibits an access to the HDD 23 at the re-start time of the operation of navigation apparatus 1.

Due to the prohibition of the HDD operation, though the application that requires data retrieval from the HDD 23 cannot be executed, the measurement of the altitude by the GPS receiver 21a can be performed. In addition, the operation mode control processing can be started (cf. FIG. 7) during the operation stopping period of the HDD 23 if the program for the operation mode control processing is stored in the ROM of the control unit 29 or the external memory 24. Therefore, if the operation of the HDD 23 is prohibited at the start time of the navigation apparatus 1, the operation of the HDD 23 is permitted according to the operation mode control processing and the operation in the normal mode is started when the vehicle leaves the highland.

(3. Advantageous Effects)

According to the navigation apparatus 1 in the above embodiments, the following effects are achieved.

(1)

In the first and second embodiments, the operation of the HDD 23 is prohibited in the highland with an altitude of 3,000 meters or higher at the start time of the operation of the navigation apparatus 1, thereby preventing the breakage of the HDD 23 even after the stopping of the vehicle in the highland.

(2)

In the third and fourth embodiments, the operation of the HDD 23 is prohibited at the start time of the operation of the navigation apparatus 1 in the highland with an altitude of 3,000 meters or higher. Instead, the operation of the navigation apparatus 1 is started by using the data stored in the external memory 24 in advance, thereby providing safety for the re-start operation of the navigation apparatus 1 in terms of preventing the breakage of the HDD 23 even after the stopping of the vehicle in the highland.

(4. Further Modifications)

Although the present invention has been fully described in connection with the preferred embodiment thereof with reference to the accompanying drawings, it is to be noted that various changes and modifications will become apparent to those skilled in the art.

For example, the altitude of the current position may be acquired by using various methods. That is, the altitude may be acquired through the GPS system, by using a barometer, or other methods. Further, by preparing and storing altitude determination data in the external memory 24 in a format that uses, for example, meshed areas by the division of latitude and longitude in the coordinate plane, the altitude of the current position may be determined according to the altitude determination data and the coordinate of the current position.

Such changes and modifications are to be understood as being within the scope of the present invention as defined by the appended claims.

What is claimed is:

1. A navigation apparatus for use in a vehicle comprising:
a hard disk drive serving as a storage for storing map data, the map data used for route guidance;
an altitude information storage unit for storing altitude information even when an operation of the navigation apparatus is halted;
an altitude acquisition unit for acquiring a current altitude;
a threshold determination unit for determining whether the current altitude is a high altitude that is equal to or higher than a threshold during a travel of a vehicle;
an altitude save unit for saving the current altitude when the current altitude is determined to be the high altitude; and
an activation control unit for prohibiting an operation of the hard disk drive in a course of activation of the navigation apparatus from a halted condition if the altitude information retrieved from the altitude information storage unit indicates the high altitude.

2. A navigation apparatus for use in a vehicle having a hard disk drive that stores map data and guiding a route based on the map data retrieved from the hard disk drive, the apparatus comprising:
an altitude acquisition unit for acquiring altitude information that indicates a current altitude; and
an activation control unit for prohibiting an operation of the hard disk drive when the altitude information from the altitude acquisition unit indicates that the current altitude is a high altitude that is equal to or higher than a threshold when the altitude information is acquired in a course of an activation of the navigation apparatus from a halted condition.

3. The navigation apparatus of claim 1, wherein
the activation control unit acquires the altitude information of a current position from the altitude acquisition unit when the navigation apparatus is re-activated from the halted condition after an interruption of an electric power supply from the vehicle, and
the activation control unit prohibits the operation of the hard disk drive if an altitude of the current position based on the acquired altitude information is equal to or greater than the high altitude.

4. The navigation apparatus of claim 1, wherein
the activation control unit acquires the altitude information from the altitude acquisition unit when the altitude information is not stored in the altitude storage unit at a time of the activation of the navigation apparatus, and
the activation control unit prohibits the operation of the hard disk drive when the current altitude based on the acquired altitude information is equal to or greater than the high altitude.

5. The navigation apparatus of claim 1, wherein
the hard disk drive stores at least the map data and an application program for performing a predetermined process by using map data,
the threshold determination unit determines whether the acquired altitude based on the altitude information from the altitude acquisition unit is the high altitude that is equal to or greater than the high altitude during the travel of the vehicle or is a medium altitude that is smaller than the high altitude and is greater than a predetermined low altitude,
a second storage unit capable of storing one of all and a part of the map data and the application program stored in the hard disk drive and capable of retaining storage contents even when the navigation apparatus is in the halted condition is further provided,
a data control unit for retrieving and for storing in the second storage unit the map data and the application program in the hard disk drive when the current altitude is determined to be the medium altitude by the threshold determination unit is further provided,
a command unit for performing processing in a highland mode that performs processing by prohibiting the operation of the hard disk drive and by performing processing with the map data and the application program retrieved from the second storage unit when the current altitude is determined to be equal to or greater than the high altitude by the threshold determination unit, and
the activation control unit prohibits the operation of the hard disk drive and starts the activation of the navigation apparatus by using the map data and the application program retrieved from the second storage unit when the altitude information retrieved from the altitude storage unit is the high altitude.

6. The navigation apparatus of claim 2, wherein
the hard disk drive stores at least the map data and an application program for performing a predetermined process by using map data,
the threshold determination unit determines whether the acquired altitude based on the altitude information from the altitude acquisition unit is the high altitude that is equal to or greater than the high altitude during the travel of the vehicle or is a medium altitude that is smaller than the high altitude and is greater than a predetermined low altitude,
a second storage unit capable of storing one of all and a part of the map data and the application program stored in the hard disk drive and capable of retaining storage contents even when the navigation apparatus is in the halted condition is further provided,
a data control unit for retrieving and for storing in the second storage unit the map data and the application program in the hard disk drive when the current altitude is determined to be the medium altitude by the threshold determination unit is further provided,
a command unit for performing processing in a highland mode that performs processing by prohibiting the operation of the hard disk drive and by performing processing with the map data and the application program retrieved from the second storage unit when the current altitude is determined to be equal to or greater than the high altitude by the threshold determination unit, and
the activation control unit prohibits the operation of the hard disk drive and starts the activation of the navigation apparatus by using the map data and the application program retrieved from the second storage unit when the altitude information retrieved from the altitude storage unit is the high altitude.

7. A computer program stored in a computer readable medium to be executed for causing a computer to be serving as the navigation apparatus of claim 1.
